(19) United States
(12) Patent Application Publication
(10) Pub. No.: US 2014/0241972 A1
(43) Pub. Date: Aug. 28, 2014

(54) ENVIRONMENTALLY FRIENDLY METHODS OF PREPARING MESOPOROUS SILICEOUS STRUCTURES

(71) Applicant: Dow Global Technologies LLC, Midland, MI (US)

(72) Inventors: Beata A. Kilos, Midland, MI (US); Cathy L. Tway, Midland, MI (US); Scott T. Matteucci, Midland, MI (US); Anne M. Kelly-Rowley, Midland, MI (US)

(21) Appl. No.: 14/352,705

(22) PCT Filed: Nov. 19, 2012
(86) PCT No.: PCT/US2012/065835

§ 371 Date: Apr. 18, 2014

Related U.S. Application Data
(60) Provisional application No. 61/563,237, filed on Nov. 23, 2011.

(51) Int. Cl. C01B 33/113

(52) U.S. Cl. CPC C01B 33/113
USPC 423/325

(57) ABSTRACT

A process for preparing structures of crosslinked silicon oxide which are mesoporous structures wherein, a portion of the materials used in the preparation of the structures are recycled for use in the preparation of additional structures.

### FIELD

The invention relates to novel processes for preparing mesoporous siliceous structures based on cross-linked silicon oxide units wherein the process includes recovery and reuse of components utilized in the process.

### BACKGROUND

Mesoporous structures refer to high-surface area porous oxides, such as silicon oxides, having an average pore size of not greater than about 100 nanometers as measured using the nitrogen adsorption/desorption method, as disclosed in Stucky et al., US Patent Publication 2009/0047329 incorporated herein by reference in its entirety. Same mesoporous oxide structures can be prepared in the form of mesocellular foams. Mesoporous silicon oxide based structures are believed to be useful in a variety of applications. Examples of such applications include thermal insulation, treatment of bleeding wounds, catalysis, molecular separations, fuel cells, adsorbents, patterned-device development, optoelectronic devices and in biological sensors, among others. These mesoporous structures are believed to provide relatively low cost, ease of handling and high resistance to photo-induced corrosion.

Mesoporous structures are generally prepared by exposing a source of a metal or metalloid, e.g. silicon oxide to cross-linking conditions in a micro-emulsion or emulsion of surfactants, and optionally one or more micelle swelling organic solvent(s), in water. The silicon oxide crosslinks on the surface of the micelles of the surfactant, and optionally one or more micelle swelling agents, to form the mesoporous structure. The size of the pores is related to the size of the micelles formed. The size of the surfactant micelles can be adjusted by swelling with one or more micelle swelling agents. The reaction medium containing the mesoporous structures is exposed to elevated temperatures so as to further adjust the pore structure and properties. The mesoporous structures are separated from the aqueous reaction medium and thereafter exposed to temperatures at which some of the organic materials contained in the mesoporous structures are removed by volatilization and/or burn out. The structure of the mesoporous materials may be altered by heating to temperatures at which they undergo calcination, for instance up to 500° C. Early mesoporous structures were reported to be crystalline and exhibited mesopores of the size of about 1.0 to about 100 nanometers. See Kresge et al., U.S. Pat. No. 5,098,684; Beck et al., U.S. Pat. No. 5,304,363; and Kresge et al., U.S. Pat. No. 5,266,541, incorporated herein by reference in their entirety. Such mesoporous silicon oxide based structures are disclosed as being crystalline in nature, brittle and having thin pore walls. Pinnavia et al. U.S. Pat. No. 6,641,657; and U.S. Pat. No. 6,506,485, incorporated herein by reference in their entirety, address this issue by preparing amorphous highly crosslinked silicon oxide mesoporous structures which are relatively dense, exhibit relatively low pure volumes and have few silanol groups in the backbone of the crosslinked silicon oxides. For certain uses, such as in insulation foams, high pore volumes are desired. In other uses high silanol concentrations are desirable, for instance where it is desirable to bond functional compounds into the mesoporous structures. See also Chmelka et al., US 2006/0118493; and Stucky US 2009/0047329 incorporated herein by reference in their entirety.

Processes for preparing known mesoporous silicon oxide based structures present challenges. Chmelka et al. and Stucky et al. disclose the use of tetraalkyl orthosilicates, such as tetraethyl orthosilicate, as a source of silicon oxide. Tetraalkyl orthosilicates are relatively costly, which limit some of the applications of mesoporous structures prepared therefrom. In addition, the use of tetraalkyl orthosilicates results in the generation of alkanol(s) byproducts, the presence of which can introduce variability in the resulting mesoporous structure, for instance a broader pore size distribution. Pinnavaia et al. U.S. Pat. No. 6,641,657; and Pinnavaia et al. U.S. Pat. No. 6,506,485 disclose the use of water soluble silicates, such as, ionic silicates, as the source of silicon oxide. The ionic silicates leave residual ions, such as alkali metal ions, in the resulting product and in the aqueous mixture left behind after recovery of the crosslinked silicon oxide mesoporous structures. The presence of the ions in the ultimate mesoporous structures can present problems for certain uses. Some of the organic materials used in the preparation of the structures can be retained in the structures after recovery of the structures from the aqueous reaction medium. The organic materials and/or ions may be left behind in the aqueous mixture after recovery of the crosslinked silicon oxide mesoporous structures. The aqueous reaction mixtures also often contain surfactants and organic materials after separation from the mesoporous structures. The presence of such materials can present challenges with respect to disposal of the aqueous mixtures. For example, it is expensive (and not environmentally friendly) to dispose of compositions containing silica and/or organic materials.

What are needed are processes for preparing mesoporous structures which facilitate recovery and recycling or reuse of reaction medium and organic materials present in preparing the highly porous siliceous materials.

### SUMMARY

The present invention is a process comprising A) contacting one or more of silicon oxide precursors (silicon oxide containing components) with an aqueous reaction medium comprising one or more surfactant(s) under conditions such that mesoporous structures are formed; B) exposing the aqueous reaction medium containing the mesoporous structures to elevated temperatures for a time sufficient to achieve the desired structure and pore size of the mesoporous structures; C) separating the mesoporous structures from the aqueous reaction medium; D) contacting the aqueous reaction medium with additional silicon oxide precursors to prepare additional mesoporous structures. The aqueous reaction medium may further comprise one or more micelle swelling agent(s) capable of swelling micelles formed by the surfactant in the aqueous reaction medium. During formation of the crosslinked silicon oxide structures by-products may be formed, such as alkanols. A portion of the surfactant, by-products, and/or micelle swelling agents may be removed from the mesoporous structures by contacting with a washing solvent for the surfactant, by-products and/or micelle swelling agent. The surfactant and/or micelle swelling agent may be separated from the washing solvent and then reused in aqueous reaction media to prepare mesoporous structures.

Another aspect of the invention is a process comprising A) contacting one or more of silicon oxide precursors containing components with an aqueous reaction medium comprising one or more surfactant(s) under conditions such that mesoporous structures are formed; B) exposing the aqueous reaction medium containing the mesoporous structures to elevated temperatures for a time sufficient to achieve the desired structure and pore size; C) separating the mesoporous structures from the aqueous reaction medium; D) separating surfactants, by-products and/or micelle swelling agent(s) contained in the mesoporous structures from the mesoporous structures. A portion of the surfactant(s), by-products and/or micelle swelling agent(s) may be removed from the mesoporous structures by exposing the mesoporous structures to temperatures at which the surfactant(s), by product(s) and/or micelle swelling agent(s) can be removed from the mesoporous structures, preferably at temperatures that the surfactant(s), by product(s) and/or micelle swelling agent(s) volatilize. The micelle swelling agent(s) or surfactant(s) volatilizing from step B may be collected and added to an aqueous reaction medium for use in preparing mesoporous structures. The aqueous reaction medium separated from the mesoporous structures may be analyzed for impurities before reuse or recycling. The results of the analysis can be used to determine if the aqueous reaction medium needs additional components such as water, surfactant(s) or micelle swelling agent(s) before being used to prepare mesoporous structures. The processes according to invention may further comprise adding one or more of virgin water, surfactant(s) and micelle swelling agent(s) to the aqueous reaction mixture before recycling or reusing the aqueous reaction medium.

The processes according to any aspect of the invention may further comprise contacting the mesoporous structures separated in Step C with a washing solvent for the micelle swelling agent(s), by-products(s) and/or the surfactant(s) under conditions that a portion of the micelle swelling agent(s), by-products(s) and/or the surfactant(s) contained in the mesoporous structures are removed; separating the micelle swelling agent(s), by-products(s) and/or surfactant(s) from the washing solvent; and using the micelle swelling agent and/or surfactant in an aqueous reaction medium for preparing mesoporous structures. Another aspect of the invention comprises a process comprising: A) contacting one or more silicon oxide precursors with an aqueous reaction medium comprising one or more surfactant(s) and one or more micelle swelling agent(s) under conditions such that mesoporous structures are formed; B) exposing the aqueous reaction medium containing the mesoporous structures to elevated temperatures for a time sufficient to achieve the desired structure and pore size, wherein the boiling point of the micelle swelling agent(s), by product(s) and/or surfactant(s) is below the elevated temperatures, so as to form a stream of volatiles of micelle swelling agent(s), by product(s) and/or surfactant(s); C) passing the volatiles though a condenser and collecting the condensed materials; and D) separating the micelle swelling agents, by product(s) and/or surfactant(s) from the condensed material collected.

The products prepared by the process may be used in a number of applications including those recited hereinbefore. The process of the invention allows for recovery and reuse or recycling, of organic materials used or generated in preparing the structures. The process of the invention allows for the removal of undesirable ingredients such as metal ions from the aqueous reaction medium before reuse in the process.

### DETAILED DESCRIPTION

The explanations and illustrations presented herein are intended to acquaint others skilled in the art with the invention, its principles, and its practical application. The specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. This application claims priority from and incorporates by reference in its entirety U.S. Provisional Application Ser. No. 61/563,237 filed Nov. 23, 2011.

The invention relates to novel processes for preparing mesoporous silicon oxide based structures. The silicon oxide based structures may be SiO₄ (silicon tetra oxide) based and contain a significant concentration of silicon tetra oxide units. It is contemplated that the following features, and their preferred embodiments as disclosed herein, may be utilized in any combination. With respect to the claimed process the following features may be utilized in any combination: wherein the aqueous reaction medium further comprises one or more micelle swelling agent(s) that partition to the micelles formed by the surfactant and which swell the micelles, that is any solvent that partitions to the oil phase in a water in oil emulsion or microemulsion; wherein the pH of the aqueous reaction medium is adjusted to accommodate the materials and process conditions used; wherein after separation of the mesoporous structures from the aqueous reaction medium a portion of the surfactant(s), by product(s) and/or micelle swelling agent is removed from the mesoporous structures by contact with a washing solvent(s) for the surfactant(s), by-products and/or micelle swelling agent(s); wherein a portion of the surfactant(s), by product(s), and/or micelle swelling agent(s) is removed from mesoporous structures by exposing the mesoporous structures to temperatures at which the surfactant by product(s), and/or micelle swelling agent can be removed from the mesoporous structures; wherein the weight ratio of micelle swelling agent to surfactant is about 1:4 to about 8:1; wherein the micelle swelling agent exhibits a boiling point below the elevated temperatures utilized to achieve the desired structure and pore size of the silicon oxide structures formed; wherein the volatiles resulting when the aqueous reaction mixture is exposed to the elevated temperatures are passed through a condenser and the condensed materials are collected; wherein the micelle swelling agent(s) are collected from the condenser and added to an aqueous reaction medium for use in preparing mesoporous structures; wherein the aqueous reaction medium separated from the mesoporous structures is analyzed for impurities before recycling or reuse; wherein one or more of virgin water, surfactant and micelle swelling agent are added to the aqueous reaction mixture before recycling or reuse; wherein the mesoporous structures separated in separated from the aqueous reaction medium are contacted with one or more washing solvent(s) for the micelle swelling agent, by-products and/or the surfactant under conditions to remove a portion of the micelle swelling agent(s), by-product(s) and/or the surfactant(s) contained in the mesoporous structures; and separating the micelle swelling agent, by-products and/or surfactant from the washing solvent; wherein the solvent is water or a polar organic solvent; wherein the solvent is one or more of alcohols, ketones, nitriles and esters; wherein the mesoporous structures are contacted with enough washing solvent to remove the desired amount of micelle swelling agent, by-products and/or surfactant from the structures; in a batch process the mesoporous structures may be washed from about 1 to about 5 times; wherein the mesoporous structures separated from the aqueous reaction medium are exposed to conditions at which the micelle swelling agent, by-products and/or surfactant volatilize and a fluid is flowed through the mesoporous structures so as to remove the volatilized micelle swelling agent, by products and/or surfactant from the mesoporous structures; wherein the one or more of hydrolyzable silicon oxide containing components comprise silicic acid or polysilicic acid; wherein the surfactant is a mono-functional hydroxyl or amine terminated C₁₋₂₀ hydrocarbyl polyalkylene oxide; wherein an organic by-product could be formed in during formation or exposing the mesoporous structures to elevated temperatures to achieve the desired structure and pore size of the silicon oxide structures further comprising the step of separating the organic by-product from the aqueous reaction medium or from the mesoporous structures prepared; contacting the aqueous reaction medium with additional silicon oxide containing components to prepare mesoporous structures; wherein metal ions are removed from the aqueous reaction medium after separation from the mesoporous structures; and, wherein the aqueous reaction medium after separation from the mesoporous structures is contacted with an ion exchange resin or ion exchange membrane. Unless stated otherwise in this specification, percent by weight refers to the weight of the aqueous reaction mixture or the mesoporous structures prepared, as indicated by the context of the passage.

The composition prepared by the process of the invention generally comprises cross-linked mesoporous structures containing silicon oxide units, preferably silicon tetraoxide (SiO₄) units. In essence chains of silicon oxide are prepared with crosslinks between the chains. In cross-linked structures a significant number of the silicon oxide units have three or four of the oxygen atoms further bonded to other silicon atoms. The cross-linked silicon oxide units are formed into structures comprised of walls defining pores which may be of any cross-sectional shape useful in porous structures, for example irregular, lamellar, circular, oval, polygonal in cross section. These pore-defining structures may be interconnected by cross-linked silicon oxide structures which are in the form of struts. The struts connecting the pore-defining structures create open areas between the walls of the pore-defining structures and the struts, which open areas are commonly referred to as windows. Structures containing a high percentage of these interconnected pore defining structures may be referred to as foams because they have relatively high pore volume and consequently low density. The formed structures contain a plurality of the connected pore defining structures, which may optionally be connected by structures, such as a plurality of struts and demonstrate tortuous open paths through the structure. The high pore volume and the tortuous paths provide significant advantages in a variety of uses as described hereinbefore. Mesoporous structures are generally accepted to have pores having a size of about 2 nanometers or greater and a size of about 100 nanometers or less, and preferably about 50 nanometers or less as defined by IUPAC. One measure of the level of cross-linking of a network of silicon oxide units is the number of units bonded to four adjacent silicon atoms (Q⁴) compared to the number of units bonded to three other adjacent silicon units (Q³) and two other adjacent silicon units (Q²). This ratio is expressed as Q⁴/(Q³+Q²). Where an oxygen atom on a silicon oxide unit is not bonded to an adjacent silicon atom it is typically bonded to a hydrogen atom which forms a silanol structure (—SiOH). The relative cross-linking density and number of silanol groups present impact how the mesoporous structures may be utilized. The cross-link density can be any density which provides the desired properties of the mesoporous structures. Preferably the mesoporous structures exhibit a crosslink ratio according to the formula Q⁴/(Q³+Q²) of about 0.5 or greater and about 1.0 or greater. Preferably the mesoporous structures exhibit a crosslink ratio according to the formula Q⁴/(Q³+Q²) of about 20.0 or less, more preferably about 8.0 or less and most preferably about 2.5 or less. Preferably the concentration of silanol groups in the cross-linked mesoporous structures is sufficient to allow the desired level of functionalization of the walls of the mesoporous structure. In one aspect of the invention the concentration of OH groups in the mesoporous structure is about 0.5 weight percent or greater and most preferably about 3.0 weight percent or greater. Preferably the concentration of OH groups from the silanol groups in the mesoporous structure is about 40.0 weight percent or less and most preferably about 32.0 weight percent or less. The pore volume is important for a number of uses of the mesoporous structures and is chosen to facilitate the designated use. The mesoporous structures preferably exhibit a pore volume of about 1.5 cm³/g (measured by N₂ adsorption/desorption as disclosed in Stucky et al., US 2009/0047329) or greater, more preferably about 2.0 cm³/g or greater and most preferably about 2.5 cm³/g or greater. The mesoporous structures preferably exhibit a pore volume of about 6.0 cm³/g or less and more preferably about 3.1 cm³/g or less. The walls of the structures that form the pores are of a sufficient thickness such that the mesoporous structures have sufficient structural integrity. Generally the wall thickness as measured from the pore to the outside surface is about 2 nm or greater and more preferably about 3 nm or greater. Generally the wall thickness as measured from the pore to the outside surface is about 6 nm or less and more preferably about 5 nm or less. The mesoporous structures of the invention are mesoporous structures having pores within the accepted definition of mesoporous structures calculated using the nitrogen adsorption/desorption isotherm, as disclosed in Stucky et al., US 2009/0047329. In one embodiment, the mesoporous structures may be referred to as mesocellular foams having pores within the accepted definition of such foams. Preferably the pores of the mesoporous structures are about 2 nanometers or greater, more preferably about 5 nanometers or greater and most preferably about 10 nanometers or greater. Preferably the pores of the mesoporous structures are about 100 nanometers or less, more preferably about 50 nanometers or less and most preferably about 20 nanometers or less. The windows as described hereinbefore typically have a different size than the pores. Preferably the windows of the mesoporous structures are about 1 nanometers or greater, more preferably about 4 nanometers or greater and most preferably about 10 nanometers or greater. Preferably the windows are about 100 nanometers or less, more preferably about 45 nanometers or less and most preferably about 20 nanometers or less. Pore size and window size are determined using the nitrogen adsorption/desorption method, as disclosed in Stucky et al., US 2009/0047329 incorporated herein by reference in its entirety. The ratio of the pore size to the window size impacts the properties of the mesoporous structures by moderating the rate of diffusion of components into and out of the pores, as well as cell strength of the mesoporous structures. Preferably the ratio of the pore size to the window size is about 0.5 or greater, more preferably about 0.8 or greater and most preferably about 1.3 or greater. Preferably the ratio of the pore size to the window size is about 2.0 or less, more preferably about 1.5 or less and most preferably about 1.3 or less. The ratios as stated may be expressed as the number stated :1, e.g. 0.5:1 to 2:1. In a one embodiment the process of the invention facilitates the preparation of mesoporous structures with low metal, metal oxide, metal ion and/or cation (such as an ammonium based cation) content. If the mesoporous structures contain metal, metal oxide, and/or metal ions, preferably about 0.5 weight percent or less of metal, metal oxide, and/or metal ions, are present, preferably about 0.2 weight percent or less and most preferably about 0.05 weight percent or less. If metal, metal oxide, metal ions and/or cations are present, they may be present in an amount of about 0.01 percent by weight or greater. Any metal, metal oxide, or metal ion that can be present in a starting material may be present. In one embodiment the metal is an alkali metal, with potassium and sodium the most likely metals. In one aspect the process facilitates the preparation of mesoporous structures that contain organic compounds. The process can be adjusted to remove or retain some of the residual organic compounds. Generally, the organic compounds are either micelle swelling agents, by-products and/or surfactants that become entrained in the cross-linked structure formed. The mesoporous structures may contain any amount of organic material that does not interfere with functioning in the desired use. Preferably the mesoporous structures contain about 20 percent by weight or less of residual organic compounds, more preferably about 5.0 percent by weight or less and more preferably about 1 percent by weight or less. If organic compounds are present they may present in an amount of about 0.01 percent by weight or greater. The mesoporous structures prepared are preferably amorphous, that is non-crystalline in nature. Preferably the mesoporous structures do not contain peaks in the 2θ=0-10° range. X-ray diffraction powder patterns of amorphous materials do not contain peaks in the 2θ=0-10°.

The process of the invention starts with one or more silicon oxide precursors which can be converted under the reaction conditions to cross-linked silicon oxides, such as silicon tetraoxide. Any silicon oxide which can be converted to cross-linked silicon oxides may be used as starting materials for this process that is a silicon oxide precursor. Materials containing silicon dioxide units are good starting materials. Exemplary starting materials include one or more of tetraalkyl orthosilicates (such as tetraethoxysilicate) colloidal silica, and/or water soluble silicates, silicic acid or polysilicic acids. Exemplary water soluble silicates include sodium silicates, potassium silicates and alkyl ammonium silicates, with sodium silicates preferred. Preferred silicon oxides include silicic acid and polysilicic acids, with polysilicic acids more preferred. Preferred polysilicic acids correspond to the formula (SiOₓ(OH)₄₋₂ₓ)ₙ wherein x is separately in each occurrence one or two and n is selected such that the polysilicic acids are water soluble, and preferably separately in each occurrence a real number of about 1 or greater and more preferably about 4 or greater. Preferably n is about a real number of 100 or less and more preferably about 50 or less. In some prior art processes the silicon oxide contains substituents (such as alkoxy groups) that are cleaved during preparation of the mesoporous structures, and form by-products (such as alkanols). The by-products may reside in the reaction medium or they may be trapped or otherwise incorporated into the mesoporous structure. Preferably, the source of silicon oxide does not generate alkanols, such as ethanol, in the process.

In embodiments where a precursor to the starting material contains ionic groups, the starting material may be prepared by replacing the ionic groups on the starting materials with hydrogen atoms. Where the starting material is silicic acid or one or more polysilicic acids, the silicic acid or one or more polysilicic acid may be prepared by replacing the ionic groups on one or more ionic silicates with hydrogen atoms. Any known process that can perform the cation replacement may be utilized. A preferred process for replacing the ionic groups with hydrogen ions involves passing the water soluble silicate through a ion exchange resin. In general the water soluble silicate is dissolved in water and passed through the ion exchange resin. Any ion exchange resin that can exchange the cations with hydrogen ions may be utilized. Among preferred ion exchange resins are AMBERLITE IR 120 hydrogen form ion exchange resin and Amberlyst 35 ion exchange resin and the like. The precursor silicate can be passed through the ion exchange resin column or contacted with ion exchange resin under any conditions which facilitate the replacement of the cations with hydrogen ions.

The source of silicon oxide is contacted with an aqueous reaction medium of water containing a surfactant. The aqueous reaction medium may need to have its pH adjusted to fit the reaction conditions and reactants utilized in preparing the desired mesoporous structures. Any pH useful for the reactants and the reaction conditions may be utilized. Depending on the reactants and the reaction conditions a pH from about 0 to 14 may be used. In one preferred embodiment, where the aqueous reaction medium exhibits an acidic pH. The pH of the aqueous reaction medium adjusted by adding a sufficient amount of acid or base to adjust the pH. The pH is chosen so that the process of cross-linking the silicon oxide units proceeds at a reasonable rate. Preferably the pH of the aqueous reaction medium is 0 or greater and more preferably about 1.0 or greater. Preferably the pH of the aqueous reaction medium is about 9 or less, more preferably 7 or less, even more preferably 5 or less, even more preferably about 4 or less and most preferably about 3 or less. The pH may be adjusted to be acidic by the addition of a strong acid. Exemplary strong acids include mineral acids, such as sulfuric acid, nitric acid, and hydrochloric acid, and strong carboxylic acids, such as acetic acid, glycolic acid, formic acid and citric acid and derivatives such as trifluoroacetic acid. A sufficient amount of acid is added to the water reaction medium to achieve the desired pH. One skilled in the art can determine the appropriate amount of acid to add to the aqueous reaction medium to achieve the desired pH.

The aqueous reaction medium contains one or more surfactants which under reaction conditions, in particular agitation, form micelles which function as templates for the formation of the pore containing structures. Any surfactant that forms micelles in water which can serve as templates for the formation of the mesoporous structures having pores of the desired size may be used in the preparation of the mesoporous structures, as a result an oil-in-water emulsion or microemulsion is formed. The surfactants are preferably nonionic in nature. Preferred surfactants contain as the hydrophilic portion one or more ethylene oxide chains and one or more hydrophobic chains. Such hydrophobic chains can be hydrocarbon chains, hydrophobic alkylene oxide chains, or a combination thereof. Exemplary hydrophobic alkylene oxide chains include propylene oxide chains and butylene oxide chains. Among exemplary surfactants containing ethylene oxide hydrophilic chains are hydrocarbyl polyethylene oxides, block copolymers of ethylene oxide and hydrophobic alkylene oxides (such as propylene oxide and butylene oxide), amine initiated block copolymers of ethylene oxide and one or more hydrophobic alkylene oxides, and other amphiphilic block copolymers. Among exemplary hydrocarbyl polyethylene oxides are alkyl polyethylene oxides and alkyl phenyl polyethylene, oxides including those disclosed in Pinnavaia U.S. Pat. No. 6,506,485 at column 4 lines 14 to 33, incorporated herein by reference. Exemplary block copolymers of ethylene oxide and hydrophobic alkylene oxides are disclosed in Pinnavaia U.S. Pat. No. 6,506,485 at column 4 lines 34 to 43, incorporated herein by reference and surfactants referred to as amphiphilic surfactants as disclosed in Chemelka et al. US 2006/0118493page 6 paragraphs 0083 to 0090, incorporated herein by reference. Exemplary amine initiated block copolymers of ethylene oxide and one or more hydrophobic alkylene oxides are disclosed in Pinnavaia U.S. Pat. No. 6,506,485 at column 4 lines 44 to 50 incorporated herein by reference. Preferred surfactants include mono-functional hydroxyl or amine terminated C₁₋₂₀ hydrocarbyl polyalkylene oxides. Preferably the surfactant is an amphiphilic block copolymer, amino-functional hydroxyl or amine terminated C₁₋₂₀ hydrocarbyl polyalkylene oxide. Preferably the mono-functional hydroxyl or amine terminated C₁₋₂₀ hydrocarbyl polyalkylene oxides correspond to the following formula R¹—X—(CH(R²)CH(R²)O)_{P}(CH₂CH₂O)_{q}H wherein R¹ is separately in each occurrence a C₁₋₂₀ hydrocarbyl group; X is separately in each occurrence O or N(R³); R² and R³ are separately in each occurrence hydrogen or lower alkyl; p is a number of 0 or greater; and q is a number of 1 or greater; wherein p and q are selected such that the compound formed functions as a surfactant and the micelles formed from the surfactant are of the desired size to form pores of the desired size. R¹ is preferably C₁₋₂₀ alkyl, aryl, alkaryl or aralkyl. In one embodiment R¹ is phenyl or alkyl phenyl. R² is preferably hydrogen or methyl. Preferably, in each unit only one R² is a lower alkyl group and the other is hydrogen. R³ is preferably hydrogen or C₁₋₄ lower alkyl and most preferably hydrogen. X is preferably O. Preferably p is a number of about 0 or greater and more preferably about 1 or greater, and most preferably about 2 or greater. Preferably p is a number of about 5 or less and most preferably about 3 or less. Preferably q is a number of about 2 or greater, more preferably about 4 or greater, even more preferably about 5 or greater and most preferably about 6 or greater. Preferably q is a number of about 15 or less, more preferably about 9 or less and most preferably about 8 or less. Such surfactants are preferably prepared by reacting an initiator, such as a compound having one or more amine or alcohol groups, with one or more alkylene oxides. In a more preferred embodiment the initiators are alcohols. In one preferred embodiment the alcohols are a mixture derived from a natural source, such as a seed oil. The amines or alcohols are alkoxylated by replacing the hydroxyl group or amino group with one or more chains of one or more alkylene oxide groups. Generally any known alkylene oxides may be reacted with the alcohol or amine to form the alkylene oxide chain. Among preferred alkylene oxides are ethylene oxide, propylene oxide, butylene oxide and the like. More preferred are ethylene oxide and propylene oxide. The alkylene oxide chains may comprise one, or more than one, alkylene oxide. Preferably the alkylene oxide chains comprise an ethylene oxide chain and a propylene or butylene oxide chain. Where two or more alkylene oxides are used they are preferably arranged in blocks. More preferred alkylene oxide chains include propylene oxide and ethylene oxide. In an even more preferred embodiment, the chain comprises a propylene oxide block bonded to the residue of the alcohol or amine and an ethylene oxide block bonded to the propylene oxide block. The preparation of alkoxylated alcohols is described in U.S. Pat. No. 5,844,115; and WO 2008/088647 (U.S. Ser. No. 12/521,827) incorporated herein by reference. In one embodiment, the surfactant is a seed oil based surfactant. Seed oil based surfactants use seed oils as the initiators for preparing polyalkylene oxides. Generally these initiators comprise a mixture of compounds capable or initiating the formation of polyalkylene oxide chains. Preferred alkoxylated alcohols are alkoxylated seed oil alcohols including those described in WO 2008/088647 (U.S. Ser. No. 12/521,827) incorporated herein by reference. Preferred alkoxylated alcohols are described by the formula R⁷—O—(CH(R²)CH(R²)O)ₐ—(CH₂CH₂O)_{b}H_{c}; wherein R² is as described hereinbefore. R⁷ is separately in each occurrence a C₁₋₂₀ straight or branched chain alkyl or alkenyl group or alkyl substituted aryl group; a is separately in each occurrence is a number of about 0 to about 6, and more preferably about 0 to about 3; b is separately in each occurrence a number of about 2 to about 10; and, c is separately in each occurrence a number of about 1 to about 6, more preferably about 1 to about 3 and most preferably 1. In one embodiment, R⁷ is a mixture of seed-oil based linear alkyl moieties with an alkyl moiety distribution as follows wherein each weight percent is based upon weight of all alkyl moieties present in the distribution and all weight percent for each distribution total 100 weight percent: Carbon atoms in Moiety Amount; C₆ 0 wt %-40 wt % C₈ 20 wt %-40 wt %; C₁₀ 20 wt %-45 wt %; C₁₂ 10 wt %-45 wt %; C₁₄ 0 wt %-40 wt %; and C₁₆-C₁₈ 0 wt %-15 wt %. Among preferred surfactants are TERGITOL™ 15S-y, where y is a numerical value associated with a surfactant, available from The Dow Chemical Company Inc., Midland, Mich.; and ECOSURF™ SA-4, SA-7, SA-9 and SA-15 seed oil based surfactants available from The Dow Chemical Company Inc., Midland Mich. and the like. The surfactants are of a suitable structure and molecular weight to form micelles of the desired size to form pores of the desired size. The particular structure impacts the molecular weight desired to prepare micelles of the desired size. Preferably the molecular weight of the surfactant is about 130 or greater and most preferably 215 or greater. Preferably the molecular weight of the surfactant is about 3,000 or less and most preferably 2,000 or less. The number of ethylene oxide units in the surfactant is preferably about 1 or greater, more preferably 2 or greater and most preferably about 3 or greater. The number of ethylene oxide units in the surfactant is preferably about 60 or less, more preferably 40 or less and most preferably about 20 or less. The amount of surfactant utilized is selected to facilitate the efficient formation of the desired mesoporous silicon oxide porous structures. The amount is preferably determined as a ratio of silicon oxide starting compounds to surfactant. Preferably the weight ratio of silicon oxide compounds to surfactant utilized is about 1:6 or greater, more preferably about 1:2 or greater and more preferably about 3:4 or greater. Preferably the weight ratio of silicon oxide compounds to surfactant utilized is about 2:1 or less, more preferably about 3:2 or less and more preferably about 1:1 or less. Within these parameters the concentration of surfactant in the aqueous reaction medium is preferably about 1 percent by weight or greater, more preferably about 1.5 percent by weight or greater and most preferably 2 percent by weight or greater. Within these parameters the concentration of surfactant in the aqueous reaction medium is preferably about 5 percent by weight or less, more preferably about 4.5 percent by weight or less and most preferably 4 percent by weight or less.

The aqueous reaction medium may optionally contain a micelle swelling agent. Micelle swelling agents useful in this process are organic solvents that partition to the micelles formed by the surfactant and which swell the micelles, that is any solvent that partitions to the oil phase in a water in oil emulsion or microemulsion. The micelle swelling agents are present to adjust the size of the micelles by swelling the micelles so as to provide a template of a desired size for preparing pore forming structures of the desired size. Micelle swelling agents preferably phase separate from a polar liquid, such as water, or are not soluble in a polar liquid. Among preferred classes of solvents are aromatic hydrocarbons, aliphatic hydrocarbons, long chain esters, long chain alcohols, long chain ketones, which may be branched or unbranched, and the like. Preferred micelle swelling agents include alkyl substituted aromatic compounds. Preferable micelle swelling agents include toluene, xylene, trimethyl benzene, ethyl benzene, diethyl benzene, cumene or a mixture thereof, with 1,3,5-trimethyl benzene most preferred. The micelle swelling agent can be a mixture of micelle swelling agents. The amount of micelle swelling agent present is chosen such that the size of the micelles is of the desired size to prepare pores of the desired size. The amount of micelle swelling agent used is generally determined to provide a desired weight ratio of micelle swelling agent to surfactant. Use of the preferred ratios of micelle swelling agent to surfactant enhances the formation of struts between the pore forming structures. Preferably the ratio of micelle swelling agent to surfactant is about 0:1 or greater, more preferably about 1:4 or greater, even more preferably about 1:1 or greater and most preferably about 2:1 or greater. Preferably the ratio of micelle swelling agent to surfactant is about 8:1 or less, more preferably about 6:1 or less, even more preferably about 4:1 or less and most preferably about 3:1 or less. Within these parameters the concentration of micelle swelling agent in the aqueous reaction medium is preferably about 1 percent by weight or greater, more preferably about 2 percent by weight or greater and most preferably 2.5 percent by weight or greater. Within these parameters the concentration of micelle swelling agent in the aqueous reaction medium is preferably about 6 percent by weight or less, more preferably about 5 percent by weight or less and most preferably 4 percent by weight or less.

The one or more silicon oxide precursors are added to the formed aqueous reaction medium. The concentration of silicon oxide containing compounds in the aqueous reaction medium is selected to facilitate the formation of cross-linked silicon oxides. Preferably the concentration of the silicon oxide containing compounds in the aqueous reaction medium is about 0.5 percent by weight or greater, more preferably about 1.0 percent by weight or greater and most preferably about 2.0 percent by weight or greater. Preferably the concentration of the silicon oxide containing compounds in the aqueous reaction medium is about 10 percent by weight or less, more preferably about 8.0 percent by weight or less and most preferably about 5 percent by weight or less. The silicon oxide containing compounds are contacted with the aqueous reaction medium with sufficient agitation to form an oil in water microemulsion or emulsion, wherein micelles are formed by the surfactant and the optional micelle swelling agent. The aqueous reaction medium is subjected to one or more forms of agitation and or shear to form an emulsion. Agitation and shear can be introduced through the use of impellers, mixer blades, ultrasonication, rotor-stator mixers and the like. For the industrial-scale production of micro-emulsions or emulsions or suspensions it is advisable to pass the aqueous reaction medium a number of times through a shear field located outside a reservoir/polymerization vessel until the desired micelle size is achieved. Exemplary apparatuses for generating a shear field are comminution machines which operate according to the rotor-stator principle, e.g. toothed ring dispersion machines, colloid mills and corundum disk mills and also high-pressure and ultrasound homogenizers. To regulate the micelle size, it can be advantageous to additionally install pumps and/or flow restrictors in the circuit around which the emulsion or suspension circulates. The contacted liquids are subjected to one or more forms of agitation and/or shear to form the desired emulsion or suspension. Agitation and shear can be introduced through the use of impellers, mixer blades, ultrasonication, rotor-stator mixers and the like. The micelle size is selected to provide the desired pore-size. The micelles form a template for the pores in the pore forming structure. The pores formed are impacted by the size of the micelles of the surfactant and/or micelle swelling agent.

After contacting the silicon oxide containing compound with the aqueous reaction medians, the aqueous reaction medium is exposed to conditions such that crosslinked silicon oxides are formed on the surface of the micelles and optionally struts are formed between the crosslinked silicon oxide structures formed on the micelles. The reaction steps and conditions for preparing the mesoporous structures can be any reaction steps and conditions known in the art, described herein or described in commonly owned copending patent application titled “High Porosity Mesoporous Siliceous Structures” filed on Nov. 23, 2011 having the Ser. No. 61/563,189, incorporated herein by reference. Included among known processes are those disclosed in Pinnavia et al. U.S. Pat. No. 6,641,657; Pinnavaia et al. U.S. Pat. No. 6,506,485; Chmelka et al., US 2006/0118493; Stucky US 2009/0047329 Kresge et al. U.S. Pat. No. 5,098,684; Beck et al. U.S. Pat. No. 5,304,363; and Kresge et al. U.S. Pat. No. 5,266,541, incorporated herein by reference in their entirety. The nature of the mesoporous structures prepared is impacted by the starting materials and the process conditions chosen as evident from the cited references.

The aqueous reaction medium is exposed to temperatures at which formation of crosslinked silicon oxides occurs on the surface of the micelles and optionally structures, such as struts, are formed of crosslinked oxide between the pore forming structures formed on the micelles. Preferably the temperature is about 20° C. or greater, more preferably about 30° C. or greater and most preferably about 40° C. or greater. Preferably the temperature is about 60° C. or less, more preferably about 50° C. or less and most preferably about 45° C. or less. The aqueous reaction medium is exposed to such temperatures for a sufficient time to form the desired structures. Preferably the aqueous reaction medium is exposed to temperatures at which the desired structures are formed for about 2 hours or greater, more preferably about 12 hours or greater and most preferably 16 hours or greater. Preferably the aqueous reaction medium is exposed to temperatures at which the desired structures are formed for about 120 hours or less, more preferably about 100 hours or less and most preferably 80 hours or less. The process can be performed under ambient conditions, such as atmospheric pressure and in the presence of air. Other pressures or environments may also be utilized.

Thereafter the aqueous reaction medium is exposed to further elevated temperatures to further adjust the pore structure and properties of the crosslinked silicon oxide based pore forming structures. This step may tailor one or more of the following features; pore size, pore volume, pore density and overall porosity. Preferably the temperature is selected so as to further adjust the pore structure and properties; preferably to tailor one or more of the following features; pore size, pore volume, pore density and overall porosity. In some processes this is referred to as aging. Preferably the temperature is about 60° C. or greater, more preferably about 70° C. or greater and most preferably about 80° C. or greater. Preferably the temperature is about 180° C. or less, more preferably about 150° C. or less and most preferably about 120° C. or less. The aqueous reaction medium is exposed to such temperatures for a sufficient time to tailor one or more of the following features; pore size, pore volume, density and overall porosity. Preferably the time for exposure to such temperatures is selected so as to further adjust the pore structure and properties; preferably to tailor one or more of the following features; pore size, pore volume, density and overall porosity. Preferably such time is about 1 hours or greater, more preferably about 6 hours or greater and most preferably 12 hours or greater. Preferably such time is about 80 hours or less, more preferably about 60 hours or less and most preferably 50 hours or less. After this step the structure formed comprises a plurality of forming structures having the desired pore structure and properties. In one embodiment the pores are interconnected by a plurality of strengthened structures such as struts. The resulting product formed can be a mixture of mesoporous structures with amorphous polymeric silicon oxide based structures, which are not in the form of mesoporous structures and/or agglomerates of the pore forming structures which are not completely mesoporous structures. Preferably the mixture contains about 40 percent by volume or greater of mesoporous structures, more preferably about 50 percent by volume or greater and most preferably about 62 percent by volume or greater. “Enhanced” as used in the context of this invention means that one of more enhancements of the structures formed listed hereinafter occurs; strengthening, formation of additional crosslinked structure, formation of thicker walls of the cross-linked structure, and the like. Preferably the product is a solid and can be separated from the aqueous reaction mixture by any known method for separating solids from liquid media. Preferably the separation is performed by filtration, centrifugation, cyclonic separation, decantation, and the like. In the steps wherein the structures formed are exposed to elevated temperatures variations in time and temperature can alter the pore volume, porosity, density and pore size. Increases in time and/or temperature generally result in increases in one or more of pore volume, porosity, density and pore size.

The mesoporous structures may be used as is after this process. Alternatively a portion or all of any residual micelle swelling agent(s), by-products, or surfactant(s) present in the mesoporous structures generally referred to hereinafter as organic compounds may be removed. Any process that removes the desired portion of the organic compounds which does not negatively impact the structure or function of the mesoporous structures may be used. In one preferred embodiment the organic compounds may be removed by contact with a washing solvent for the organic compounds. In one embodiment the contacting may result in extraction of the organic compounds from the mesoporous structures. Any washing solvent that removes the desired amount of the organic compounds may be utilized. Preferred washing solvents are polar organic solvents or water. Preferred polar organic solvents are alcohols, ketones, nitriles and esters. More preferred polar organic solvents are alcohols and ketones, with ethanol and acetone preferred. The mesoporous structures are either soaked in the washing solvents or the washing solvents are passed through a bed of the mesoporous structures. The mesoporous structures are contacted with the washing solvent for sufficient time to remove the desired portion of the organic compounds. In the embodiment where the polar solvent or water are passed through a bed of the mesoporous structures, the polar solvents or water may be contacted with the mesoporous structures in a sufficient amount to remove the desired amount of organic compounds. In a batch process the polar solvent or water are passed through the bed of the mesoporous structures a number of times. The number of times that the polar solvent or water is passed through the mesoporous structures is chosen to result in the desired level of organic compounds in the mesoporous structures. Polar solvent or water may be passed through the mesoporous structures one or more times, preferably 2 or more times and most preferably 3 or more times. The maximum number of times is based on the desired final level of organic compounds desired in the mesoporous structures. Generally, 5 or less times is preferable. The conditions for the extraction can be any which facilitate the removal of the organic compounds from the mesoporous structures. Ambient temperatures, pressures and environments may be used, although others may be contemplated.

In another embodiment, the organic compounds micelle swelling agent, by-products, and/or surfactant may be removed from the mesoporous structures formed by volatilizing them away or burning them out. This is achieved by exposing the mesoporous structures prepared to conditions such that the organic compounds contained in the mesoporous structures, such as micelle swelling agents, by-products, and/or surfactants, undergo volatilization or degradation and are removed from the mesoporous structures. The mesoporous structures are exposed to temperatures at which the organic compounds undergo volatilization or degradation. Preferably the temperatures are greater than 160° C. and most preferably about 300° C. or greater. Preferably the temperatures are about 500° C. or less, more preferably about 400° C. or less, and most preferably about 300° C. or less. It is preferable to flow a fluid through the mesoporous structures to remove the volatilized organic compounds or degradation products. Any fluid which does not harm the mesoporous structures may be used for this purpose. Preferably the fluid is in the gaseous state. Among preferred fluids are air, nitrogen or inert gases. The flow rate is sufficient to remove the volatilized organic compounds or degradation products efficiently. Preferred flow rates are about 5 cm³/g or greater, more preferably about 25 cm³/g or greater and most preferably about 50 cm³/g or greater. Preferred flow rates are about 100 cm³/g or less, more preferably about 75 cm³/g or less and most preferably about 60 cm³/g or less. Alternatively a vacuum may be applied to the mesoporous structures while being exposed to elevated temperatures to remove the volatilized organic compounds or degradation products. The mesoporous structures are removed from the environment in which the volatilization or burnout of organic compounds is performed. The recovered materials may be reused in aqueous reaction media for the purpose of preparing additional mesoporous structures.

The mesoporous structures may be used as recovered or can be further processed for the desired use. The mesoporous structures can be formed into a desired shape with or without a binder. Alternatively the mesoporous structures can be reacted with components to functionalize the mesoporous structures. Such processes are known in the art. In some embodiments the residual silanol groups are reacted with compounds which react with the hydroxyl groups to replace the hydrogen ion to affix such compounds to the crosslinked silicon oxide structure. This functionalization allows the mesoporous structures to perform certain desired functions, see for instance Stucky US 2009/0047329.

After the mesoporous structures are removed from the aqueous reaction medium, the reaction medium can be reused for the preparation of additional mesoporous structures. A portion of or all of the reaction medium may be reused in the first step of this process, that is as the aqueous reaction medium for forming mesoporous structures. When previously used aqueous reaction medium is used for the first step, all of the aqueous reaction medium may be recycled or a portion of the reaction medium may be newly added, that is previously unused in this process. Preferably greater than 50 percent by weight of the aqueous reaction medium may be recycled, more preferably greater than 75 percent by weight and most preferably greater than 90 percent by weight. In one embodiment a portion of the aqueous reaction medium is previously used in the process and another portion of the aqueous reaction medium is make up water, surfactant and/or micelle swelling agent. The use of make-up material (eg., water, surfactant and/or micelle swelling agent) prevents the aqueous reaction medium from degrading to a point at which the process cannot run efficiently. In this embodiment the amount of make up material is about 1 percent by weight or greater and most preferably 5 percent by weight or greater. In this embodiment the amount of make up material is about 90 percent by weight or less and most preferably 75 percent by weight or less. The recovered aqueous reaction media may be analyzed for impurities or concentration of components. Such analysis can be performed using known analytical techniques. A portion of the recovered aqueous reaction medium may be taken and analyzed for impurities and/or the concentration of components in the aqueous reaction media recovered, such as micelle swelling agent and/or surfactants. Alternatively one or more sensors may be included in the process wherein the sensor or sensors measure the concentration of impurities and/or the concentration of the components in the aqueous reaction media.

In the embodiment wherein organic materials, such as micelle swelling agents by-products and/or surfactants, are volatilized off from the reaction medium such materials can be collected as discussed hereinbefore. The volatilized materials may be recovered in a condenser. In one embodiment the volatiles recovered may include water from the reaction medium which may also be recovered and reused as described herein. The collected organic materials can be reused or recycled for use in the starting aqueous reaction medium. Preferably greater than 50 percent by weight of the organic materials utilized in the aqueous reaction medium may be recycled or reused, preferably greater than 75 percent by weight and more preferably greater than 90 percent by weight. In the embodiment, wherein the organic materials are removed from the mesoporous structures using a washing solvent, the organic materials can be separated from the washing solvent, the polar organic solvent or water, and recycled for use or reused in the aqueous reaction medium. To recover the surfactant from the washing solvent, the washing solvent with the surfactant dispersed therein is exposed to evaporation conditions to volatilize the washing solvent away leaving the surfactant which can be used in the aqueous reaction medium for preparing additional mesoporous structures. As a first stage the washing solvent and surfactant may be subjected to rotary evaporation conditions to remove a portion of the washing solvent. Thereafter the remaining washing solvent can be removed by evaporation, for example in a nitrogen box. Where the micelle swelling agents, organic by-products or surfactants are volatile at the temperatures at which the structures are exposed to elevated temperatures, the volatile components can be separated from the stream of volatiles. This can be achieved by passing the volatiles through a condenser and separating the components using known techniques.

In some embodiments the recovered organic material may contain impurities that need to be removed before reuse or recycling. In some embodiments the impurities are unreacted silicon oxides or partially reacted silicon oxides. If these materials are solid they can be removed by decantation, filtration (for instance by using membranes, filters or screens), centrifugation and the like. Where the impurities are ions (such as metal ions) the organic materials can be passed through an ion exchange resin or membrane to remove the ions or by washing them with water to remove the ions. The aqueous reaction medium recovered can be subjected to a purge step wherein a set amount of the aqueous reaction medium can be removed and replaced with fresh components to achieve the desired starting concentration. Alternatively the concentration of components can be determined and analytically or using sensors and the concentration can be adjusted to get to the desired starting amount of the components. This can be achieved by removing some of the recovered material, adding fresh components or both. Mesoporous structures recovered using reused aqueous reaction media or components in the aqueous reaction media exhibit the expected properties.

### Illustrative Embodiments of the Invention

The following examples are provided to illustrate the invention, but are not intended to limit the scope thereof. All parts and percentages are by weight unless otherwise indicated.

### Mesoporous Structure Preparation Process

A microemulsion sample is made by first dissolving surfactant in 1.6 M HCl at room temperature. To the microemulsion solution is slowly added an amount of 1,3,5-trimethylbenzene (TMB) to give the desired micelle swelling agent/surfactant ratio, and then the mixture is heated to 40° C. After 60 minutes, a silica source materials (i.e., tetraethyl ortho silicate, freshly prepared silicic acid or Na silicate) is added. Silicic acid is prepared by dissolving 5 g of sodium silicate in 30 ml H₂O and contacting it with an ion exchange process using 25 ml of Amberlite resin (IR 120 hydrogen form, Sigma Aldrich), in particulate form, with stirring for 10 min in a plastic beaker. The mixture is stirred at 40° C. for 20 to 24 hours. The resulting milky solution is transferred to a sealed container and held at 100° C. for 24 hours. The resulting mixture is cooled to ambient temperature. The precipitated solid product is filtered to isolate the precipitate. The precipitate, (which may be washed as described hereinafter), is dried at ambient temperature for 2 days. The recovered reaction product is calcined at 500° C. for 8 hours in air flow.

### Washing Procedure

The reaction precipitate, isolated as described above, and dried at ambient temperature for two days is added to a jar of solvent and gently mixed. Number 4 qualitative filter paper is placed in a Buchner funnel and wetted with solvent. With the aspirator on, the slurry is poured in to the funnel. Additional solvent is used to rinse the remaining precipitate from the jar. The filter cake is allowed to run dry before stopping the vacuum. The washing step is performed four times for each precipitate sample. The recovered solid is thereafter calcined at 500° C. for 8 hours in air flow. The isolated wash solvent is rotary evaporated and placed in small jars. The small jars are placed under a nitrogen flow to remove the remaining solvent. Recovered surfactant remains in the jars after drying.

### Ingredients

Tetraethyl orthosilicate 208.33 g/mole
1,3,5-trimethyl benzene 120 g/mole
Plutonic P123 surfactant 5750 grams per mole comprising a block copolymer of 20 units of ethylene oxide, 70 units of propylene oxide and 20 units of ethylene oxide.

Several Examples are performed wherein mesoporous structures are prepared using Pluronic P123 surfactant, 1,3,5-trimethyl benzene and tetraethyl orthosilicate using the process as described hereinbefore. In some examples the surfactant is recovered from the mesoporous structures and in some cases reused. Different polar organic solvents are used as extraction solvents. The mesoporous structures are examined for pore volume using nitrogen adsorption/desorption; X ray diffraction for crystallinity. The starting amounts of ingredients and properties of the mesoporous structures are compiled in Table 1. Extraction solvent refers to the solvent used to recover the surfactant in the experiment

TABLE 1

| | Example | | | | |
|---|---|---|---|---|---|
| | 1 | 2 | 3 | 4 | 5 |
| Surfactant weight, g | 12.00 | 12.00 | 9.00 | 9.00 | 9.00 |
| trimethyl benzene, ml | 20.83 | 20.83 | 15.63 | 15.63 | 15.63 |
| Tetraethyl orthosilicate, ml | 28.30 | 28.30 | 21.22 | 21.22 | 21.22 |
| 1.6M HCl, ml | 450 | 450 | 337.5 | 337.5 | 337.5 |
| Washing Solvent | ethanol | ethanol | toluene | acetone | ethyl |
| | | | | | acetate |
| Surfactant recovered by extraction g | 10.3176 | 7.71 | 1.9525 | 7.3928 | 3.9674 |
| % Surfactant Recovered (wt. %) | 85.98 | 64.25 | 24.41 | 89.14 | 49.59 |
| BET Surface Area m²/g | 778.108 | 773.5922 | 754.34 | 771.83 | 767.25 |
| BJH Desorption cumulative pore | 2.532447 | 2.391224 | 2.64 | 2.74 | 2.66 |
| volume cm³/g | | | | | |
| Adsorption average pore width | 119.5016 | 113.6796 | 101.07 | 99.80 | 103.28 |
| (4 V/A by BET) Angstrom | | | | | |
| BJH Desorption average pore | 98.507 | 93.771 | 127.75 | 128.41 | 125.76 |
| diameter Angstroms | | | | | |
| % OH (wt loss to 100° C.) | 3.17 | 5.061 | 3.378 | 2.285 | 3.659 |
| % Other wt loss 100° C. to 600° C.) | 1.18 | 0.523 | 0.21 | 0.36 | 4.48 |

BET Surface Area m²/g, and BJH Desorption cumulative pore volume cm³/g. Adsorption average pore width (4V/A by BET) Angstrom, BJH Desorption average pore diameter Angstroms are determined according to the procedure described below. The surface area, pore size and pore volumes of the mesoporous cellular foams are measured by nitrogen adsorption at 77.4 K using the conventional technique on a Micromeritics ASAP 2420 apparatus. Prior to the adsorption measurements, the samples are degassed in vacuum at room temperature for at least 12 hours. The pore size distributions, average pore diameter and pore volumes are determined from the adsorption branch of isotherms using the Barret-Joyner-Halenda (BJH) procedure. In a similar fashion, the window sizes are probed using the desorption branch of the N₂ isotherm data. The surface area is calculated using the BET method.

### Use of Recycled Surfactant to Prepare Mesoporous Structures

Mesoporous structures are prepared using fresh (previously unused) surfactant and recycled surfactant (previously used reactions and recovered) surfactant. Table 2 shows the reactants, recovery solvent and the results of analysis of the Mesoporous Structures. The term ‘surfactant generation’ refers to the number of times that a surfactant sample has been used for synthesis. For example, generation 1 is fresh surfactant being used for the first time, generation 2 is surfactant that has been recovered and reused, and generation 3 is surfactant that has been used twice before in reactions and is being used for the third time.

TABLE 2

| | Example | | | | | | |
|---|---|---|---|---|---|---|---|
| | 1 | 2 | 3 | 4 | 5 | 6 | 7 |
| Surfactant Generation | 1 | 2 | 2 | 1 | 2 | 1 | 3 |
| Surfactant Source | Fresh | Ex 4 | Ex 5 | Fresh | Ex 2 | Fresh | Ex 10 |
| Recovered from | na | acetone | ethyl | na | ethanol | na | ethanol |
| Solvent: | | | acetate | | | | |
| Surfactant weight, g | 2.00 | 2.00 | 2.00 | 6.00 | 6.00 | 3.00 | 3.00 |
| Trimethyl benzene, ml | 3.47 | 3.47 | 3.47 | 10.42 | 10.42 | 5.21 | 5.21 |
| Tetraethyl orthosilicate, | 4.72 | 4.72 | 4.72 | 14.15 | 14.15 | 7.07 | 7.07 |
| ml | | | | | | | |
| 1.6M HCl, ml | 75 | 75 | 75 | 225 | 225 | 112.5 | 112.5 |
| Washing Solvent | none | none | none | Ethanol | ethanol | Ethanol | ethanol |
| Surfactant recovered by | na | na | na | 4.1569 | 5.0255 | 1.0459 | 1.4734 |
| extraction, g | | | | | | | |
| % Surfactant Recovered | na | na | an | 69.3 | 83.8 | 35 | 49 |
| BET Surface Area m²/g | 728.713 | 748.6896 | 779.7986 | 759.1428 | 753.6589 | 778.1915 | 770.0859 |
| BJH Desorption | 2.273869 | 2.763140 | 2.384976 | 2.814158 | 2.89029 | 2.635643 | 2.479268 |
| cumulative pore volume | | | | | | | |
| cm²/g | | | | | | | |
| Adsorption average | 104.7904 | 124.0921 | 112.2172 | 131.8742 | 140.183 | 125.4498 | 119.3787 |
| pore width (4 V/A by | | | | | | | |
| BET) Angstrom | | | | | | | |
| BJH Desorption | 70.742 | 78.335 | 99.02 | 97.316 | 112.118 | 104.064 | 94.610 |
| average pore diameter | | | | | | | |
| Angstroms | | | | | | | |
| % OH (wt loss to 100° C.) | 8.759 | 8.647 | 10.080 | 6.264 | 5.314 | 4.012 | 7.551 |
| % Other wt loss to 100° C. | 1.123 | 1.23 | 1.41 | 0.8375 | 1.100 | 0.8041 | 1.228 |
| 600° C.) g | | | | | | | |

The examples in Tables 1 and 2 describe surfactant recovery and recycle through three (3) generations, making new mesoporous structures using Tetraethyl orthosilicate (TEOS) as the silica source, P123 as the surfactant, and trimethyl benzene as the swelling agent. Examples have also been generated using sodium silicate as the silica source, P123 as the surfactant and trimethyl benzene as the swelling agent. Using this particular combination of reactants, mesoporous structures have been demonstrated out to four (4) generations. In another embodiment, a different surfactant, TERGITOL™ 15-S-7, in combination with freshly prepared silicic acid and trimethyl benzene swelling agent have been used to make mesoporous structures. The TERGITOL™ surfactant has been recovered, using ethanol for particle washing, and the surfactant recovered in this manner used again. In this case, three generations of surfactant recycle have been demonstrated to produce mesoporous structures in each generation. It should be noted that while the specific examples described have used only surfactant recovered from previous synthesis steps to demonstrate the next generation recycle synthesis, those skilled in the art will recognize that any combination of recovered surfactant with fresh surfactant can be used in practice to produce mesoporous structures.

Parts by weight as used herein refers to 100 parts by weight of the composition specifically referred to. Any numerical values recited in the above application include all values from the lower value to the upper value in increments of one unit provided that there is a separation of at least 2 units between any lower value and any higher value. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

1. A process comprising
A) contacting one or more of silicon oxide containing components selected from sodium silicates, potassium silicates, alkyl ammonium silicates, silicic acid and polysilicic acids with an aqueous reaction medium comprising one or more surfactants under conditions such that mesoporous structures are formed;
B) exposing the aqueous reaction medium containing the mesoporous structures to elevated temperatures for a time sufficient to achieve the desired structure and pore size of the mesoporous structures;
C) separating the mesoporous structures from the aqueous reaction medium;
D) contacting the aqueous reaction medium with additional silicon oxide containing components to prepare additional mesoporous structures.

2. A process according to claim 1 wherein the aqueous reaction medium further comprises one or more micelle swelling agent(s) capable of swelling micelles formed by the surfactant in the aqueous reaction medium.

3. A process according to claim 1 wherein one or more organic by-products are formed during preparation of the mesoporous structure by exposing the aqueous reaction medium to elevated temperatures.

4. A process according claim 3 wherein the mesoporous structures separated from the aqueous reaction medium are exposed to conditions at which the micelle swelling agents, by-products and/or surfactants volatilize and flowing a fluid is through the mesoporous structures so as to remove the volatilized micelle swelling agents, by-products and/or surfactants from the mesoporous structures.

5. A process according to claim 3 wherein a portion of the surfactants, by-products, and/or micelle swelling agents is removed from the mesoporous structures by exposing the mesoporous structures to temperatures at which the surfactants, by-products, and/or micelle swelling agents can be removed from the mesoporous structures.

6. A process according to claim 3 wherein the micelle swelling agents, by-products exhibits and/or surfactants exhibit boiling points below the temperature utilized when the aqueous reaction mixture is exposed to elevated temperatures to achieve the desired structure and pore size of the mesoporous structures.

7. A process according to claim 1 wherein volatiles are formed during exposure of the aqueous reaction mixture to elevated temperatures to achieve the desired structure and pore size of the mesoporous structures and the volatiles are passed through a condenser and the condensed materials are collected.

8. A process according to claim 7 wherein the condensed material contain surfactants, by-products, micelle swelling agents and/or and water and separating the micelle swelling agent, by-products and/or surfactants from the condensed material.

9. A process according to claim 3 wherein after separation of the mesoporous structures from the aqueous reaction medium, a portion of byproducts formed, the surfactant(s) and/or micelle swelling agent(s) is removed from the mesoporous structures by the contacting them with a washing solvent.

10. A process according to claims 9 further comprising separating the micelle swelling agents, by-products and/or surfactants from the washing solvent.

11. A process according to claim 9 wherein the washing solvent is water or a polar organic solvent.

12. A process according to claim 9 wherein the washing solvent is one or more of alcohols, ketones, esters, and nitriles.

13. A process according to claim 3 wherein the micelle swelling agents and/or surfactants recovered added to aqueous reaction media used in the preparation of mesoporous structures.

14. A process according to claim 3 wherein the weight ratio of micelle swelling agent to surfactant is about 1:4 to about 8:1.

15. A process according to claim 1 wherein the aqueous reaction medium separated from the mesoporous structures is analyzed for impurities before use for preparation of additional mesoporous structures.

16. A process according to claim 3 wherein one or more of virgin water, surfactant and micelle swelling agent are added to the aqueous reaction mixture before use for preparation of additional mesoporous structures.

17. A process according to claim 1 wherein the one or more of silicon oxide containing components comprise silicic acid or polysilicic acid.

18. A process according to claim 1 wherein the surfactant is an amphiphilic block copolymer, amino-functional hydroxyl or amine terminated C1-20 hydrocarbyl polyalkylene oxide.

19. A process according to claim 1 wherein metal ions or organic by-products are removed from the aqueous reaction medium after separation from the mesoporous structures.

20. A process according to claim 1 wherein the aqueous reaction medium after separation from the mesoporous structures is contacted with an ion exchange resin or ion exchange membrane.
